(19) United States
(12) Patent Application Publication
(10) Pub. No.: US 2015/0108098 A1
(43) Pub. Date: Apr. 23, 2015

(54) SINGLE CRYSTAL WELDING OF DIRECTIONALLY SOLIDIFIED MATERIALS

(71) Applicants: SIEMENS AKTIENGESELLSCHAFT, Munchen (DE); FRAUNHOFER GESELLSCHAFT ZUR FÖRDERUNG DER ANGEWANDTEN FORSCHUNG E.V., Munchen (DE)

(72) Inventors: Nikolai ARJAKINE, Berlin (DE); Georg BOSTANJOGLO, Berlin (DE); Bernd BURBAUM, Falkensee (DE); Andres GASSER, Aachen (DE); Torsten JAMBOR, Dusseldorf (DE); Torsten JOKISCH, Neuenhagen bei Berlin (DE); Stefanie LINNERBRINK, Kreuzau (DE); Selim MOKADEM, Nurnberg (DE); Michael OTT, Mulheim an der Ruhr (DE); Norbert PIRCH, Aachen (DE); Rolf WILKENHÖNER, Kleinmachnow (DE)

(21) Appl. No.: 14/504,115

(22) Filed: Oct. 1, 2014

(30) Foreign Application Priority Data
Oct. 18, 2013 (EP) 13189316.6

(51) Int. Cl. B23K 26/34; B23K 26/00

(52) U.S. Cl. CPC B23K 26/345; B23K 26/0012
USPC 219/76.14

(57) ABSTRACT

By way of the targeted selection of method parameters in laser welding, namely feed rate, laser power beam diameter and powder mass flow, the temperature gradient can be set in a targeted manner, which temperature gradient is decisive for the single crystal growth during laser build-up welding.

### CROSS-REFERENCE TO RELATED APPLICATIONS

The present application claims priority of European Patent Application No. EP13189316, filed Oct. 18, 2013, the contents of which are incorporated by reference herein.

### TECHNICAL FIELD

The invention relates to a process for welding directionally solidified metallic materials.

### TECHNICAL BACKGROUND

SX nickel-based superalloys reinforced with γ′ cannot be subjected to build-up welding with fillers of the same type in overlapping welding tracks in one or more layers either by means of conventional welding processes or by high-energy processes (laser, electron beam). The problem is that a microstructure with misorientation already forms in the case of an individual welding track in the marginal region close to the surface. For the subsequent overlapping track, this means that the solidification front in this region has no available SX nucleus, and the region with misorientation (no SX microstructure) expands further in the overlapping region. Cracks are formed in this region.

For SX nickel-based superalloys reinforced with γ′, the welding processes used to date are not able to homogeneously build up a weld metal by overlapping in one or more layers with an identical SX microstructure. In the case of a single track on an SX substrate, the local solidification conditions vary in such a manner that, depending on the position, dendritic growth is initiated proceeding from the primary roots or the secondary arms. In this case, of the various possible dendrite growth directions, the direction which prevails is the direction with the most favorable growth conditions, i.e. the direction with the smallest angle of inclination with respect to the temperature gradient. The cause of the formation of misorientations in the SX microstructure during the powder build-up welding of SX nickel-based superalloys reinforced with γ′ has not yet been completely clarified. It is suspected that, when the dendrites meet one another from various growth directions, secondary arms may break away and serve as nuclei for the formation of a misoriented microstructure. In addition, powder particles which have not completely melted in the melt may serve as nuclei for the formation of a misoriented microstructure in the marginal region close to the surface. To solve this problem, a procedure which involves realizing growth conditions which favor only one growth direction for the dendrites is therefore proposed for the powder build-up welding of SX nickel-based superalloys reinforced with γ′. In addition, the procedure ensures that the powder particles are melted completely in the melt.

### SUMMARY OF THE INVENTION

Therefore, it is an object of the invention to solve the problem mentioned above.

To solve this technical problem relating to the formation of a non-single-crystal microstructure in the marginal region of a single track close to the surface, a procedure is proposed for build-up welding with laser radiation in which this problem does not arise or arises to such a small extent that overlapping in one or more layers is possible without the formation of cracks at room temperature.

### BRIEF DESCRIPTION OF THE DRAWINGS

FIG. 1 shows a schematic course of the process,

FIG. 2 shows a gas turbine,

FIG. 3 shows a turbine blade or vane, and

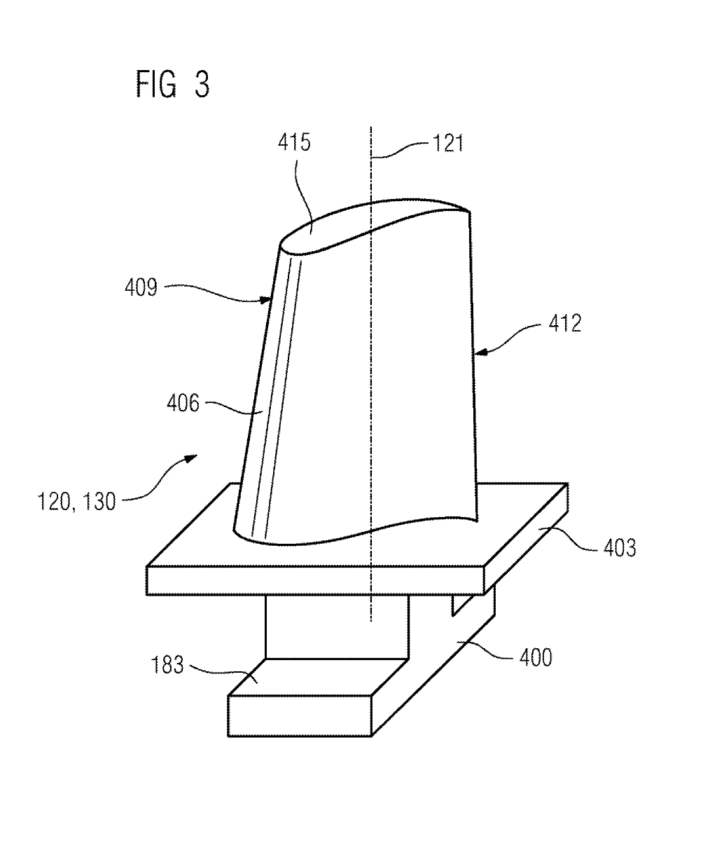

FIG. 4 shows a list of superalloys.

### DESCRIPTION OF AN EMBODIMENT

The description and the figures represent only exemplary embodiments of the invention.

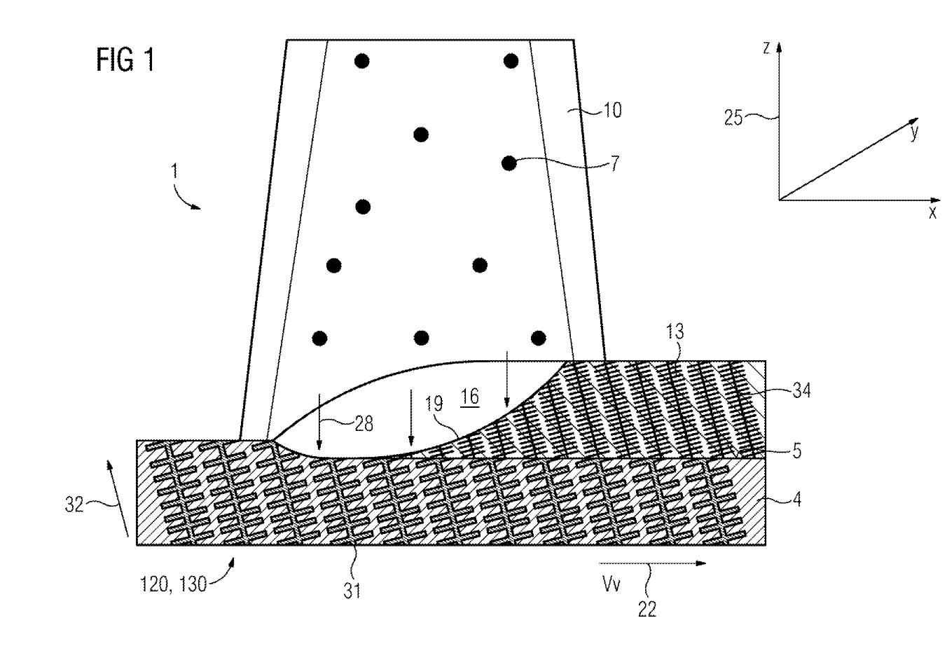

FIG. 1 schematically shows the course of the process, with an apparatus 1.

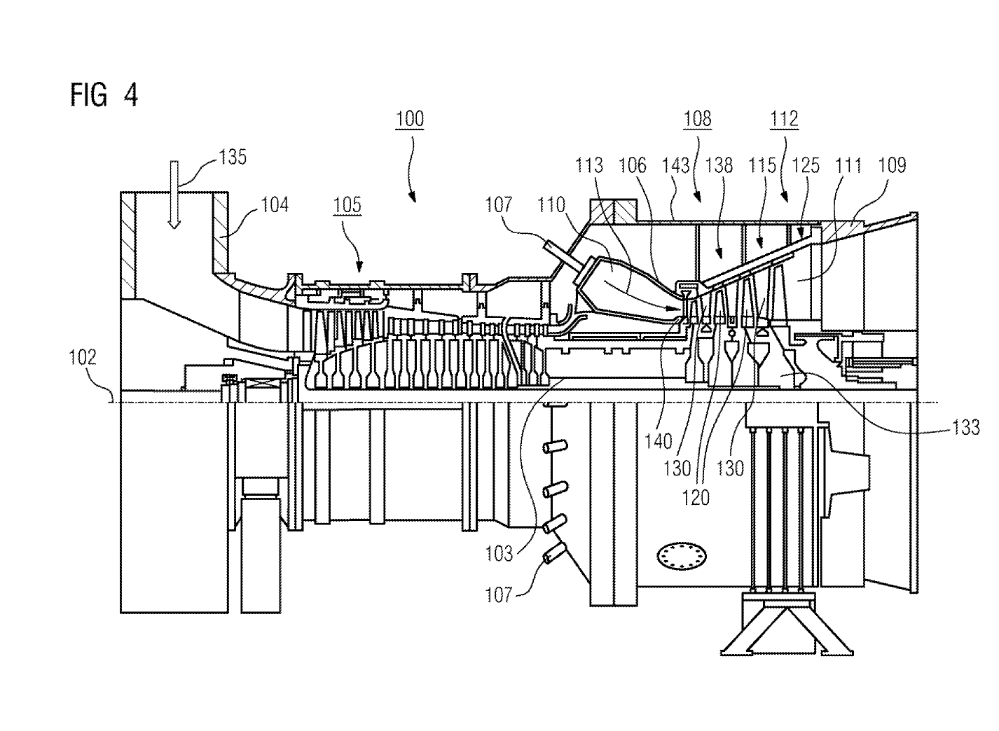

The component 120, 130 to be repaired has a substrate 4 made of a superalloy, in particular of a nickel-based superalloy as shown in FIG. 4.

Very particularly, the substrate 4 consists of a nickel-based superalloy.

The substrate 4 is repaired by applying new material 7, in particular by means of powder, to the surface 5 of the substrate 4 by build-up welding.

Referring to FIG. 1, this is effected by supplying material 7 and a welding beam, preferably a laser beam 10 of a laser, which melts at least the supplied material 7 and preferably also parts of the substrate 4.

Here, use is preferably made of powder. The diameter of the powder particles 7 is preferably so small that they can be melted completely by a laser beam and a sufficiently high temperature of the particles 7 results.

In this respect, a melted region 16 and an adjoining solidification front 19 and, downstream thereof, an already resolidified region 13 are present on the substrate 4 during the welding.

The apparatus of the invention preferably comprises a laser (not shown) with a powder supply unit and a movement system (not shown), with which the laser beam interaction zone and the impingement region for the powder 7 on the substrate surface 5 can be moved in the direction 22. In this case, it is preferable that the component (substrate 4) is neither preheated nor overaged by means of heat treatment.

That region on the substrate 4 which is to be reconstructed is preferably subjected to build-up welding in layers.

The layers are preferably applied in a meandering manner, unidirectionally or bidirectionally, in which case the scan vectors of the meandering movements from layer to layer are preferably turned in each case by 90°, in order to avoid bonding errors between the layers.

The dendrites 31 in the substrate 4 and the dendrites 34 in the applied region 13 are shown in FIG. 1.

A system of coordinates 25 is likewise shown.

The substrate 4 moves relatively in the x direction 22 at the scanning speed Vᵥ.

The z temperature gradient

$$\frac{\partial T}{\partial Z}$$

28 is present on the solidification front 19.

The welding process is carried out with process parameters concerning scanning speed Vᵥ of the feed rate, laser power, beam diameter and powder mass flow which lead to a local orientation of the temperature gradient on the solidification front which is smaller than 45° with respect to the direction of the dendrites 31 in the substrate 4. This ensures that exclusively that growth direction which continues the dendrite direction 32 in the substrate 4 is favored for the dendrites 34. This requires a beam radius which ensures that that part of the three-phase lines which delimits the solidification front 19 is covered completely by the laser beam.

The approximative condition for a suitable inclination of the solidification front 19 with respect to the dendrite direction 32 of the dendrites 31 in the substrate 4 is the following:

$$\frac{\frac{1}{λ} \cdot A \cdot {I}_{L}}{\sqrt{{( \frac{\partial T}{\partial x} )}^{2} + {( \frac{\partial T}{\partial γ} )}^{2} + {( \frac{1}{λ} A \cdot {I}_{L} )}^{2}}} < 0.707 = cos ( 45 ° )$$

A: Degree of absorption of the substrate,
I_{L}: Laser intensity,
λ: Specific thermal conductivity of the substrate,
T: Temperature,
   wherein

$$\frac{\partial T}{\partial x}$$

and

$$\frac{\partial T}{\partial γ}$$

depend on the scanning speed Vᵥ.

The condition gives rise to a process window, depending on the material, concerning the intensity of the laser radiation (approximate top hat), the beam radius relative to the powder jet focus, the scanning speed Vᵥ and the powder mass flow.

The complete coverage of the melt with the laser radiation ensures, in the case of the coaxial procedure, a longer time of interaction between the powder particles and the laser radiation and a consequently higher particle temperature upon contact with the melt.

The particle diameter and therefore the predefined time of interaction should bring about a temperature level which is high enough for complete melting. Given an appropriate particle temperature and residence time in the melt, a sufficiently high temperature level of the melt should have the effect that the particles melt completely.

By virtue of the process parameters and mechanisms described above, the prerequisites for epitaxial single-crystal growth in the weld metal with an identical dendrite orientation in the substrate are ensured. Since only one dendrite growth direction normal to the surface is activated during the welding process, the subsequent flowing of the melt into the interdendritic space is facilitated during solidification, and the formation of hot cracks is avoided. This results in a weld quality which is acceptable for structural welding (e.g. for the purposes of repairing or joining in a region of the component subject to a high level of loading).

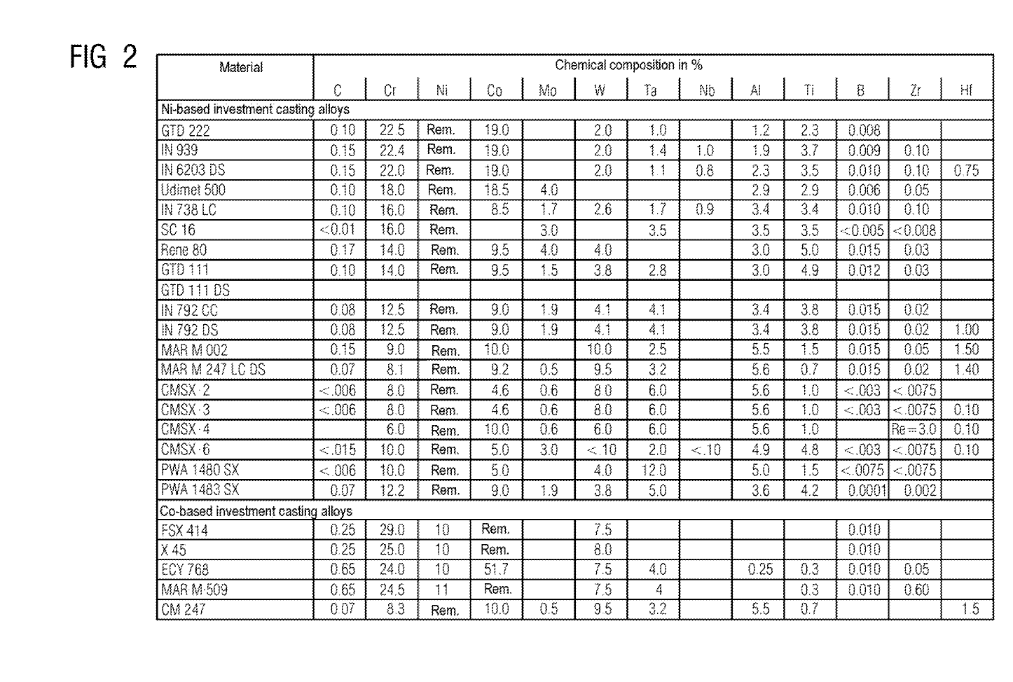

FIG. 2 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses. Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density. A protective aluminum oxide layer (TGO=thermally grown oxide layer) is formed on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer, to be present on the MCrAlX, consisting for example of ZrO₂, Y₂O₃—ZrO₂, i.e. unstabilized, partially stabilized or fully stabilized by yttrium oxide and/or calcium oxide and/or magnesium oxide.

The thermal barrier coating covers the entire MCrAlX layer.

Columnar grains are produced in the thermal barrier coating by suitable coating processes, such as for example electron beam physical vapor deposition (EB-PVD).

Other coating processes are possible, e.g. atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1. A process for directional solidification of a weld seam during build-up welding of a substrate of a component, wherein the component is directionally solidified and comprises dendrites, which extend in a substrate dendrite direction;
the weld is formed using a weld material in meltable powder particle form;
the process comprises selecting process parameters with respect to scanning speed of a laser, laser power, laser welding beam diameter, powder jet focus and/or powder mass flow, wherein the parameters are configured such that they lead to a local orientation of the temperature gradient on a solidification front which is smaller than 45° with respect to the substrate dendrite direction of the dendrites in the substrate and in which:
$$\frac{\frac{1}{λ} \cdot A \cdot {I}_{L}}{\sqrt{{( \frac{\partial T}{\partial x} )}^{2} + {( \frac{\partial T}{\partial γ} )}^{2} + {( \frac{1}{λ} A \cdot {I}_{L} )}^{2}}} < 0.707 = cos ( 45 ° )$$
wherein:
A: Degree of absorption of the substrate,
I_{L}: Laser intensity,
λ: Specific thermal conductivity of the substrate,
T: Temperature.

2. The process as claimed in claim 1, further comprising forming a melt which is generated by supplying powder and/or material of the substrate, wherein the melt is formed on and in the substrate; and
covering the melt completely by a welding beam.

3. The process as claimed in claim 2, wherein the powder supplied is applied in layers.

4. The process as claimed in claim 1, wherein the substrate comprises a nickel-based superalloy.

5. The process as claimed in claim 1, wherein a diameter of the powder particles is small enough that the particles melt completely in a welding laser beam and the particles have a sufficiently high temperature.

6. The process as claimed in claim 1, wherein the temperature of the melted powder particles is at least 20° C. above the melting temperature of the powder particles.

7. The process as claimed in claim 1, wherein a laser is used for the welding.

8. The process as claimed in claim 2, wherein the welding beam is a laser beam and the melt is overlapped when in the laser beam.

9. The process as claimed in claim 4, wherein the superalloy comprises columnar grains and has a single-crystal microstructure.
